(19) United States
(12) Patent Application Publication
(10) Pub. No.: US 2025/0117240 A1
(43) Pub. Date: Apr. 10, 2025

(54) Virtual Machine Management based on Predicted Processor Unit Utilization

(71) Applicant: International Business Machines Corporation, Armonk, NY (US)

(72) Inventors: Nan Qi, Bejing (CN); Yan Li, Bejing (CN); Ji Shan Xing, Bejing (CN); Kai Huang, Bejing (CN); Chen Guang Zhao, Bejing (CN)

(21) Appl. No.: 18/483,062

(22) Filed: Oct. 9, 2023

(51) Int. Cl. G06F 9/455; G06F 9/48

(52) U.S. Cl. CPC G06F 9/45558; G06F 9/4881; G06F 2009/4557

(57) ABSTRACT

A computer implemented method manages execution of jobs on virtual machines. Processor units identify a job for scheduling. The processor units identify host machines with free cores on which the virtual machines are allocated. The processor units determine a number of free cores on the host machines. The processor units determine whether a host machine in the host machines having a number of host attributes needed by the job has free cores and idle cores available for backfilling the job based on a predicted core usage for the job in response to an absence of a sufficient number of free cores being available to meet predicted core usage. The processor units dispatch the job to a virtual machine on the host machine in response to the host machine having the number of host attributes and the free cores and idle cores available for backfilling the job.

### BACKGROUND

The disclosure relates generally to an improved computer system and more specifically to managing virtual machines based on predicted processor utilization by the virtual machines.

Virtual machines are used in many different environments. A virtual machine is a software-based emulation of a physical computer. A virtual machine can run in isolated environments on a host computer. A virtual machine has its own virtual hardware. This virtual hardware can include a processor, memory, storage, input output, and other components that can be mapped to real hardware on the host computer. The use of virtual hardware enables a virtual machine to run an entirely separate operating system on the host computer.

With the increased adoption of hybrid cloud infrastructures, virtual machines can enable increased integration of on-premises networks and cloud infrastructures. In virtual machine can be easily moved between an on-premises network and a cloud without needing changes. As result, the use of virtual machines can provide increased portability for migration, backup, and disaster recovery. Further, virtual machines can be quickly provisioned or de-provisioned based on demand for services. As workloads increase, additional virtual machines can be provisioned in the cloud to handle the increased demand and provide services that can meet service level objectives.

For example, a cloudburst can involve an application that primarily runs a private cloud or data center and then is run in a public cloud in response to an increase in demand. Applications running in a private cloud can provide processing for various requests. When a surge in demand exceeds the capacity of the private cloud, bursting can occur in which the extra demand is offloaded to a public cloud. The extra demand can be handled through maintaining incidences of virtual machines that are idle and available for this type of demand. In other examples, new virtual machines can be provisioned to handle the increased demand. In this manner, an increase in processing resources can be made available when needed.

### SUMMARY

According to one illustrative embodiment, a computer implemented method manages execution of jobs on virtual machines. A number of processor units identifies a job for scheduling. The number of processor units identifies host machines with free cores on which the virtual machines are allocated. The number of processor units determines a number of free cores on the host machines. The number of processor units determines whether a host machine in the host machines having a number of host attributes needed by the job has a number of free cores and idle cores available for backfilling the job based on a predicted core usage for the job in response to an absence of a sufficient number of free cores being available to meet the predicted core usage. The number of processor units dispatches the job to a virtual machine on the host machine in response to the host machine having the number of host attributes and the number of free cores and idle cores available for backfilling the job. According to other illustrative embodiments, a computer system and a computer program product for managing execution of jobs and virtual machines are provided.

### BRIEF DESCRIPTION OF THE DRAWINGS

FIG. 1 is an illustration of a block diagram of a computing environment is depicted in accordance with an illustrative embodiment;

FIG. 2 is an illustration of a block diagram of a virtual machine environment is depicted in accordance with an illustrative embodiment;

FIG. 3 is an illustration of a workload manager in accordance with an illustrative embodiment;

FIG. 4 is a graph depicting patterns of core usage over the lifetime of jobs in accordance with an illustrative embodiment;

FIG. 5 is a graph depicting core usage for jobs on a virtual machine in accordance with an illustrative embodiment;

FIG. 6 is a graph depicting core usage for jobs on a virtual machine in accordance with an illustrative embodiment;

FIG. 7 is a graph illustrating of processor resource usage without backfilling in accordance with an illustrative embodiment;

FIG. 8 is a graph illustrating of processor resource usage with backfilling in accordance with an illustrative embodiment;

FIG. 9 is a flowchart of a process for managing job execution in points with an illustrative embodiment;

FIG. 10 is a flowchart of a process for job execution on virtual machines in accordance with an illustrative embodiment;

FIG. 11 is a flowchart of process for determining whether the host machine in the host machines having the number of host attributes needed by the job has the number of free cores and idle cores in accordance with an illustrative embodiment;

FIG. 12 is a flowchart of a process for determining core usage by the number of current jobs in accordance with an illustrative embodiment;

FIG. 13 is a flowchart of process for dispatching a job in accordance with an illustrative embodiment;

FIG. 14 is a flowchart of a process for requesting a new virtual machine in accordance with an illustrative embodiment;

FIG. 15 is a flowchart of a process for managing a job in accordance with an illustrative embodiment;

FIG. 16 is a flowchart of a process for managing a job in accordance with an illustrative embodiment;

FIG. 17 is a flowchart of a process for training a machine learning model to determine a pattern of core usage in accordance with an illustrative embodiment; and

FIG. 18 is a block diagram of a data processing system in accordance with an illustrative embodiment.

### DETAILED DESCRIPTION

A computer implemented method manages job execution on virtual machines. A number of processor units identifies a job for scheduling. The number of processor units identifies host machines with free cores on which the virtual machines are allocated. The number of processor units determines a number of free cores on the host machines. The number of processor units determines whether a host machine in the host machines having a number of host attributes needed by the job has a number of free cores and idle cores available for backfilling the job based on a predicted core usage for the job in response to an absence of a sufficient number of free cores being available to meet the predicted core usage. The number of processor units dispatches the job to a virtual machine on the host machine in response to the host machine having the number of host attributes and the number of free cores and idle cores available for backfilling the job. As result, the illustrative embodiments provide a technical effect of increasing usage of processor resources already allocated virtual machines for processing jobs.

In the illustrative embodiments, as part of determining whether a host machine in the host machines having the number of host attributes needed by the job has the number of free cores and idle cores, the number of processor units determines a core usage by a number of current jobs on the host machine and compares a predicted runtime and the predicted core usage for the job with the core usage determined for the number of current jobs on the host machine to determine the number of free and idle cores. Thus, the illustrative embodiments provide a technical effect of determining free and idle cores.

In the illustrative embodiments, as part of determining the core usage by the number of current jobs, the number of processor units identifies a pattern of core usage for each job in the number of current jobs on the host machine. The number of processor units determines the core usage by the number of current jobs on the host machine using the pattern of core usage for each job in the number of current jobs on the host machine. As result, the illustrative embodiments provide a technical effect of increasing accuracy in determining core usage by the number current jobs.

In the illustrative embodiments, the number of processor units dispatches the job directly to the virtual machine on the host machine in response to the host machine having the sufficient number of free cores needed for the predicted core usage. As a result, the illustrative embodiments provide a technical effect of using virtual machines with sufficient free cores to process a job.

In the illustrative embodiments, the number of processor units requests a new virtual machine with a number of cores needed for the job. As result, the illustrative embodiments provide a technical effect requesting a virtual machine when host machines with sufficient free cores and idle cores are not available.

In the illustrative embodiments, the job is a highest priority job in a queue in a highest priority queue. Thus, the illustrative embodiments provide a technical effect processing jobs with higher priorities in higher priority queues.

In the illustrative embodiments, the number of processor units suspend a backfill job on the host machine in response to processor usage on the host machine reaching a threshold. Thus, the illustrative embodiments provide a technical effect giving priority to currently executing jobs on a virtual machine.

In the illustrative embodiments, the number of processor units resume the backfill job in response to the processor usage on the host machine being lower than the threshold. As result, the illustrative embodiments provide a technical effect enabling managing the execution of the backfill job.

In the illustrative embodiments, a native job on the host machine has a higher priority than a backfill job on the host machine. Thus, the illustrative embodiments provide a technical effect giving priority to native jobs already running on a host machine.

A computer system comprises a number of processor units. The number of processor units executes program instructions to identify a job for scheduling. The number of processor units executes program instructions to identify host machines with free cores on which virtual machines are allocated. The number of processor units executes program instructions to determine a number of free cores on the host machines. The number of processor units executes program instructions to determine whether a host machine in the host machines having a number of host attributes needed by the job has a number of free cores and idle cores available for backfilling the job based on a predicted core usage for the job in response to an absence of a sufficient number of free cores being available to meet the predicted core usage. The number of processor units executes program instructions to dispatch the job to a virtual machine on the host machine in response to the host machine having the number of host attributes and the number of free cores and idle cores available for backfilling the job. As result, the illustrative embodiments provide a technical effect of increasing usage of processor resources already allocated virtual machines for processing jobs.

In the illustrative embodiments, as part of determining whether the host machine in the host machines having the number of host attributes needed by the job has the number of free cores and idle cores, the number of processor units further executes the program instructions to determine a core usage by a number of current jobs on the host machine and to compare a predicted runtime and the predicted core usage for the job with the core usage determined for the number of current jobs on the host machine to determine the number of free and idle cores. Thus, the illustrative embodiments provide a technical effect of determining free and idle cores.

In the illustrative embodiments, as part of determining the core usage by the number of current jobs, the number of processor units further executes the program instructions to identify a pattern of core usage for each job in the number of current jobs on the host machine. The number of processor units further executes the program instructions to determine the core usage by the number of current jobs on the host machine using the pattern of core usage for each job in the number of current jobs on the host machine. As result, the illustrative embodiments provide a technical effect of increasing accuracy in determining core usage by the number current jobs.

In the illustrative embodiments, the number of processor units further executes the program instructions to dispatch the job directly to the virtual machine on the host machine in response to the host machine having the sufficient number of free cores needed for the predicted core usage. As a result, the illustrative embodiments provide a technical effect of using virtual machines with sufficient free cores to process a job.

In the illustrative embodiments, the number of processor units further executes the program instructions to request a new virtual machine with a number of cores needed for the job. As result, the illustrative embodiments provide a technical effect requesting a virtual machine when host machines with sufficient free cores and idle cores are not available.

In the illustrative embodiments, the job is a highest priority job in a queue in a highest priority queue. Thus, the illustrative embodiments provide a technical effect processing jobs with higher priorities in higher priority queues.

In the illustrative embodiments, the number of processor units further executes the program instructions to suspend a backfill job on a host machine in response to processor usage on the host machine reaching a threshold. Thus, the illustrative embodiments provide a technical effect giving priority to currently executing jobs on a virtual machine.

In the illustrative embodiments, the number of processor units further executes the program instructions to resume the backfill job in response to the processor usage on the host machine being lower than the threshold. As result, the illustrative embodiments provide a technical effect enabling managing the execution of the backfill job.

In the illustrative embodiments, a native job on a host machine has a higher priority than a backfill job on the host machine. Thus, the illustrative embodiments provide a technical effect giving priority to native jobs already running on a host machine.

In the illustrative embodiments, a computer program product manages execution of jobs on virtual machines. The computer program product comprises a computer readable storage medium having program instructions embodied therewith. The program instructions are executable by a computer system to cause the computer system to identify a job for scheduling. The program instructions are executable by a computer system to cause the computer system to identify host machines with free cores on which the virtual machines are allocated. The program instructions are executable by a computer system to cause the computer system to determine a number of free cores on the host machines. The program instructions are executable by a computer system to cause the computer system to determine whether a host machine in the host machines having a number of host attributes needed by the job has a number of free cores and idle cores available for backfilling the job based on a predicted core usage for the job in response to an absence of a sufficient number of free cores being available to meet the predicted core usage. The program instructions are executable by a computer system to cause the computer system to dispatch the job to a virtual machine on the host machine in response to the host machine having the number of host attributes and the number of free cores and idle cores available for backfilling the job. As result, the illustrative embodiments provide a technical effect of increasing usage of processor resources already allocated virtual machines for processing jobs.

In the illustrative embodiments, as part of determining whether the host machine in the host machines having the number of host attributes needed by the job has the number of free cores and idle cores, the program instructions are further executable by the computer system to cause the computer system determine a core usage by a number of current jobs on the host machine and compare a predicted runtime and the predicted core usage for the job with the core usage determined for the number of current jobs on the host machine to determine the number of free and idle cores. Thus, the illustrative embodiments provide a technical effect of determining free and idle cores.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

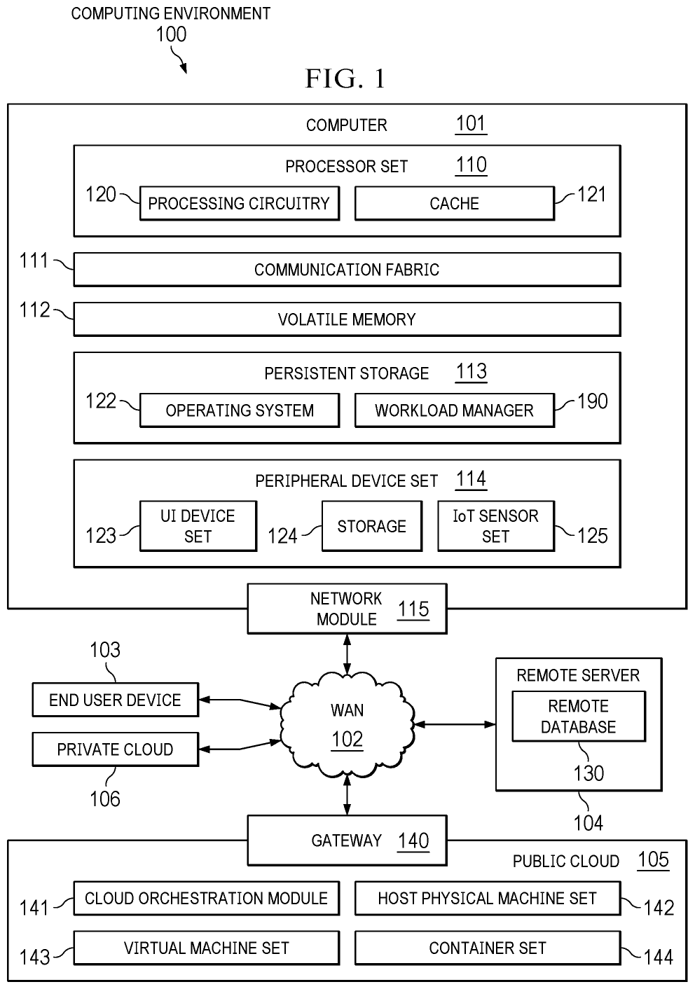

With reference now to the figures in particular with reference to FIG. 1, an illustration of a block diagram of a computing environment is depicted in accordance with an illustrative embodiment. Computing environment 100 contains an example of an environment for the execution of at least some of the computer code involved in performing the inventive methods, such as workload manager 190. In addition to workload manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and workload manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in workload manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in workload manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, a workload manager can monitor when and how many virtual machines are used during high periods of demand for applications and services. This kind of monitoring can be performed during cloud bursts in which a private cloud or network comes overwhelmed with demand and bursts its excess workload to a public cloud to prevent undesired service disruptions.

Processor usage is not always consistent during the processing of jobs. Usage of cores in processors can vary over time depending on the type of job. For example, a job may prepare data, process data, and save data. The core usage may be lower during the preparing data and setting up an environment at the beginning of a job and cleaning data and saving of data at the end of the job as compared to the processing of data during the job. As a result, the processor usage during the running of one or more jobs on a host machine may be such that another job can be run on the same host machine when sufficient free cores and idle cores are available in view of the manner in which cores are used during job execution. This type of job allocation can be referred to as backfilling.

Backfilling new jobs by using free and idle cores that are available during the processing on a host to run new jobs can reduce the need to provision new virtual machines. For example, the number of virtual machines provisioned for use in a public cloud for processing jobs in a private cloud can be reduced through using free and idle cores available on host machines in the private cloud. This type of reduction in allocating virtual machines can be applied to any computing environment in addition to or in place of a hybrid cloud.

Thus, illustrative embodiments provide a computer implemented method, apparatus, system, and computer program product for managing virtual machines. This management includes managing the scheduling of jobs in the virtual machines based on the usage of cores and host machines. In one illustrative example, a number of processor units identifies a job for scheduling. The number of processor units identifies host machines with free cores on which the virtual machines are allocated. The number of processor units determines a number of free cores on the host machines. The number of processor units determines whether a host machine in the host machines having a number of host attributes needed by the job has a number of free cores and idle cores available for backfilling the job based on a predicted core usage for the job in response to an absence of a sufficient number of free cores being available to meet the predicted core usage. The number of processor units dispatches the job to a virtual machine on the host machine in response to the host machine having the number of host attributes and the number of free cores and idle cores available for backfilling the job.

As used in herein, a “number of” when used with reference items means one or more items. For example, in number of processor units is one or more processors.

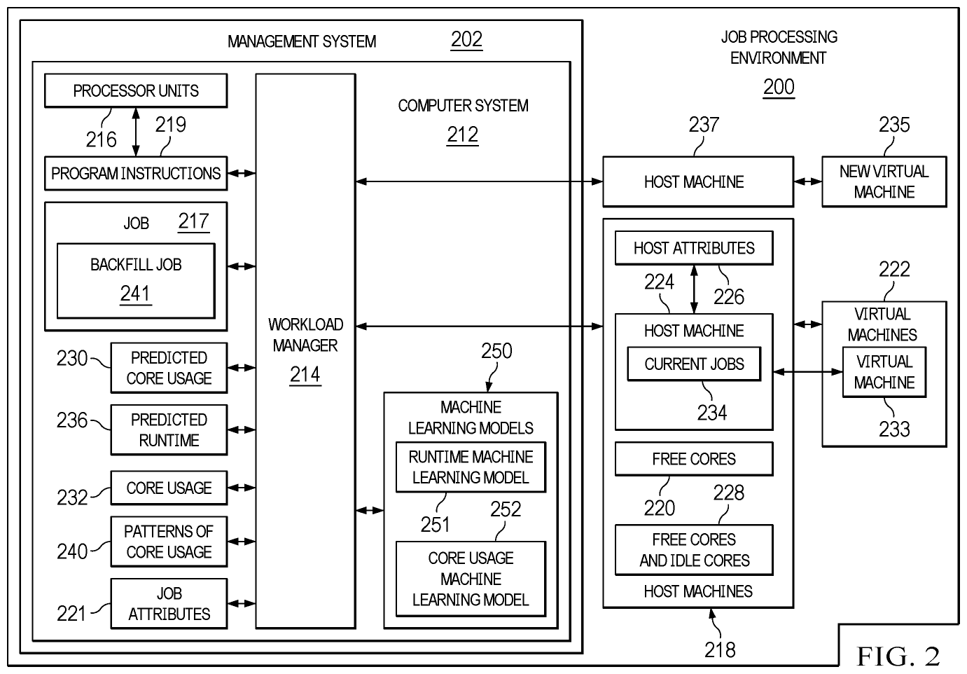

With reference now to FIG. 2, an illustration of a block diagram of a virtual machine environment is depicted in accordance with an illustrative embodiment. In this illustrative example, job processing environment 200 includes components that can be implemented in hardware such as the hardware shown in computing environment 100 in FIG. 1.

In this illustrative example, management system 202 in job processing environment 200 manages the execution of jobs on virtual machines. In this illustrative example, management system 202 comprises computer system 212 and workload manager 214. Workload manager 214 is located in computer system 212. Workload manager 214 may be implemented using workload manager 190 in FIG. 1.

Workload manager 214 can be implemented in software, hardware, firmware, or a combination thereof. When software is used, the operations performed by workload manager 214 can be implemented in program instructions configured to run on hardware, such as a processor unit. When firmware is used, the operations performed by workload manager 214 can be implemented in program instructions and data and stored in persistent memory to run on a processor unit. When hardware is employed, the hardware can include circuits that operate to perform the operations in workload manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of′ when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of′ means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 219 implementing processes in the illustrative examples. In other words, program instructions 219 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 219 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, workload manager 214 identifies job 217 for scheduling. Job 217 can be selected in a number of different ways. In this example, job 217 is a highest priority job in a queue in a highest priority queue.

Workload manager 214 also identifies host machines 218 with free cores 220 on which the virtual machines 222 are allocated. Workload manager 214 determines a number of free cores 220 on the host machines 218. Workload manager 214 determines whether host machine 224 in host machines 218 having a number of host attributes 226 needed by job 217 has a number of free cores and idle cores 228 available for backfilling job 217 based on predicted core usage 230 for job 217 in response to an absence of a sufficient number of free cores 220 being available to meet predicted core usage 230 for job 217.

The number of host attributes 226 can take a number of different forms. For example, the number of host attributes 226 can be selected from at least one of central processing unit attributes, memory attributes, storage attributes, network attributes, quality of service, snapshot capability, and other types of attributes for host machines 218. Central processing unit attributes can include, for example, available cores, allocated threats, virtualization extensions, and other attributes. Memory attributes can be memory size, memory type, access speed, and latency. In this example, storage attributes can include, for example, disk latency, disk throughput, storage type, and provisioning time. Network attributes can include network bandwidth and network resources.

In this illustrative example, a job is a unit of work that is run in computer system 212. Jobs can have different patterns of processing that result in different usage of processing resources. In this example, the processing resources are in the form of cores in host machines 218. A host machine is computer or computer system on which virtual machines can be initialized to run jobs. A core is an individual processor in a central processing unit (CPU), or other type of processing unit located in a host machine. A processing unit can have multiple cores. Each core is capable of executing its own tasks and thread simultaneously with other cores.

Further in this example, a host attribute can be a characteristic of physical hardware that can be mapped to virtual hardware in the virtual machine. The virtual machine needs selected resources, the host will need to have the physical resources that can be mapped to those virtual resources. Further, in this example, a free core is a core that is not allocated to a job. An idle core is a core allocated to a job but is not being used. As result, whether free cores and idle cores 228 are used depends on the host machine on which the cores are located.

In this example, backfilling means that a job can be added be run along with other currently running jobs on a host machine. The idea is to fill in the back of the schedule or unused processing resources that may be available through free cores and idle cores 228.

In this example, workload manager 214 allocates job 217 to virtual machine 233 on host machine 224 in response to host machine 224 having the number of host attributes 226 and number of free cores and idle cores 228 available for backfilling job 217.

In another illustrative example, workload manager 214 can dispatch job 217 directly to the virtual machine 233 on host machine 224 in response to host machine 224 having the sufficient number of free cores 220 needed for predicted core usage 230 by job 217. In other words, virtual machine 233 is available to run job 217 on host machine 224 and can be allocated a sufficient number of free cores 220 in host machine 224 based on predicted core usage 230 by job 217.

In yet another illustrative example, workload manager 214 requests an allocation of new virtual machine 235, with a number of cores needed for job 217. In this case, new virtual machine 235 can be allocated on host machine 237 that is located on a different network or same network as host machines 218. For example, if host machines 218 are located on a local area network or a private cloud, new virtual machine 235 can be allocated in another network such as a public cloud. Allocation from a public cloud can include the cost that is desirable to reduce or minimize the different illustrative examples.

In this example, in determining whether host machine 224 in host machines 218 having a number of host attributes 226 needed by job 217 has the number of free cores and idle cores 228, workload manager 214 determines core usage 232 by a number of current jobs 234 on the host machine 224. Workload manager 214 compares predicted runtime 236 and predicted core usage 230 for job 217 with core usage 232 determined for the number of current jobs 234 on host machines 218 to determine the number of free and idle cores 228.

In this illustrative example, predicted runtime 236, predicted core usage 230, and core usage 232 can be determined using machine learning models 250. For example, runtime machine learning model 251 in machine learning models 250 can be used to determine predicted runtime 236. Historical runtimes for different jobs can be collected and associated with job attributes 221 for the jobs to form a training dataset. Job attributes 221 can include, for example, user, application, project, command, command argument, input_data_size, resource requirement, and other suitable attributes about a job.

This training dataset can be used to train runtime machine learning model 251 to predict run time for jobs based on job attributes 221 for the jobs. In one illustrative example, runtime machine learning model 251 can implement machine learning logistic regression to predict the run time for job 217 in determining predicted runtime 236 for job 217.

As another example, in machine learning models 250 can be used to determine predicted core usage 230 for job 217. Historical data on core usage during the running of jobs can be collected and used to generate curves that describe the usage of cores at different times during the running of the jobs. These curves can be referred to as job core consumption curves. These job core consumption curves can be classified into clusters to form patterns of core usage 240. Each cluster of curves can be represented by a single curve that is a pattern of core usage. This single curve can be generated by using the maximum core usage at each point in time from each curve in the cluster of curves. These patterns of core usage can be associated with job attributes 221 for the jobs to form a training dataset that is used to training core usage machine learning model 252.

This machine learning model can determine a pattern of core usage in patterns of core usage 240 for a job based on job attributes 221 for the job. This pattern of core usage can be used to predict the core usage for a job over time. For example, in determining core usage 232 by the number of current jobs 234 running on host machine 224, workload manager 214 identifies a pattern of core usage in patterns of core usage 240 for each job in the number of current jobs 234 on host machine 224 to determine core usage 232 by the number of current jobs 234 on the host machine 224. In other words, by classifying each of current jobs 234 to a particular pattern of core usage, the usage of the cores over time can be determined for each of current jobs 234. A pattern of core usage is also determined for job 217 that is used to determine predicted core usage 230. The remaining time for current jobs 234 can be compared to predicted core usage 230 based on predicted runtime 236 to determine what number of free cores and idle cores 228 is needed to run job 217 with current jobs 234 as backfill job 241.

When job 217 is allocated using a sufficient number of free cores and idle cores 228, job 217 is backfill job 241. Workload manager 214 can manage job 217 while job 217 execute as a backfill job 241. For example, workload manager 214 can suspend backfill job 241 on host machine 224 in response to processor usage on host machine 224 reaching a threshold. The threshold can take a number of different forms such as, for example, 90% processor usage, 95% processor usage, or some other threshold value. Further in this example, workload manager 214 resumes backfill job 241 in response to the processor usage on host machine 224 being lower than the threshold.

In these examples, a native job on host machine 224 has a higher priority than backfill job 241 on the host machine 224. In this manner, current jobs 234 running on host machine 224 can be given a priority a new job such as backfill job 241 being added to backfill or use free cores and idle cores 228 that are available.

In one illustrative example, one or more solutions are present that overcome a problem with using processor resources to process jobs with virtual machines on host machines. As a result, one or more technical solutions may provide an ability to increase the usage of cores in host machines to process jobs. The illustrative examples can identify free cores and idle cores that are available for use in processing new jobs. By matching up the processing resources needed by a new job with the available records and idle cores, a virtual machine processing one or more current jobs can process a new job as a backfill job using the free cores and idle cores.

Thus, the need to request allocating a new virtual machine can be reduced through this use of free cores and idle cores to process new job. As result, costs associated with requesting a new virtual machine in a network environment such as a hybrid cloud can be reduced.

In the illustrative example, computer system 212 can be configured to perform at least one of the steps, operations, or actions described in the different illustrative examples using software, hardware, firmware, or a combination thereof. As a result, computer system 212 operates as a special purpose computer system in which workload manager 214 in computer system 212 enables managing the execution of jobs of virtual machines with a more efficient use of processor resources. In particular, workload manager 214 transforms computer system 212 into a special purpose computer system as compared to currently available general computer systems that do not have workload manager 214.

In the illustrative example, the use of workload manager 214 in computer system 212 integrates processes into a practical application for managing a job execution that increases the performance of computer system 212. In other words, workload manager 214 in computer system 212 is directed to a practical application of processes integrated into workload manager 214 in computer system 212 that identifies a job that is rescheduled for processing, identify host machines with free cores, determine the number free cores on those host machines, and determine whether a host machine and those host machines of the type needed by the job has a number free cores available for backfilling the job in response to an absence of a sufficient number free cores being available to meet the predicted core usage for the job. The job can be allocated to a virtual machine on the host machine in response to that host machine having the number of host attributes and the number free cores and idle cores available for backfilling the job.

The illustration of job processing environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, host machines 218 can be located on a network such as a local area network or a private cloud. Allocation of a new virtual machine with a new host machine can be made in another network such as a public cloud. This allocation can be performed through sending request to management software, hypervisor, or other component that manages virtual machines.

Thus, the different illustrative examples can be implemented in various types of networks including at least one of a hybrid cloud, and local area network, a wide area network, the Internet, an intranet, or some combination thereof. When used with a hybrid cloud, the different illustrative examples can reduce the need to request allocations of virtual machines on a public cloud by more efficient uses of processing resources in the private cloud and existing resources on a public cloud. A more efficient use of resources can be performed through taking into account available processing resources such as at least one of a free core or an idle core available in host machines in the private cloud. These resources can be used to perform backfilling of a job to perform the job with other jobs when available processing resources are present.

Additionally, the different illustrative examples can also be implemented for reducing energy consumption. For example, host machines can be placed into hibernation or sleep mode when not used to reduce energy consumption. By more efficiently using processing resources in host machines currently processing jobs, the need to power up or wake up host machines can be reduced.

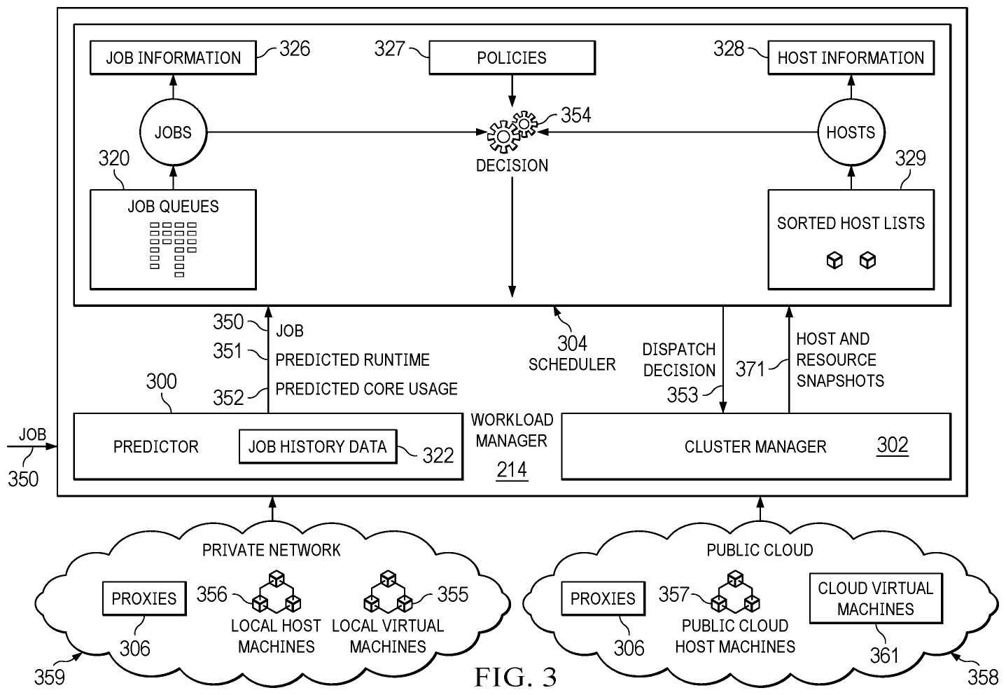

Turning now to FIG. 3, an illustration of a workload manager is depicted in accordance with an illustrative embodiment. In the illustrative examples, the same reference numeral may be used in more than one figure. This reuse of a reference numeral in different figures represents the same element in the different figures.

Examples of components that can be used to implement workload manager 214 are shown in this figure. As depicted, workload manager 214 comprises predictor 300, cluster manager 302, and scheduler 304. These components can work with proxies 306 to manage the execution of jobs.

As depicted, job 350 is submitted to workload manager 214 through predictor 300 in this example. Predictor 300 determines predicted runtime 351 and predicted core usage 352 for job 350 using job history data 322. Predicted runtime 351 is an example of predicted runtime 236 in FIG. 2. Predicted core usage 352 is an example of predicted core usage 230 in FIG. 2.

In this example, predictor 300 can use job history data 322 to create artificial intelligence models to predict predicted runtime 351 and predicted core usage 352 for job 350. For example, machine learning logistic regression can be used to predict the runtime of a job to obtain predicted runtime 351 for job 350. This model can be trained using job history data and the runtime to the jobs.

As another example, predicted core usage 352 can be determined using historical information about core consumption over job lifetimes. This information can be used to generate curves of core usage during the running of jobs.

In one example, data can be periodically collected for overall core consumption during the lifetime of the job. A curved line can be created to describe how many cores were used at different points in time during the lifetime of the job. These curves can identify different workload patterns.

Further, these curves can be classified using a machine learning model to determine predicted core usage 352 for job 350. The classification of these curves can be used to generate patterns of core usages such as patterns of core usage 240 in FIG. 2.

Thus, when a new job such as job 350 is received with the request particular host attributes, predicted runtime 351 and predicted core usage 352 can be determined. This predicted core usage can occur indicating the predicted usage of cores while job 350 runs. In this example, the core usage for any particular times during the running of job can be determined based on the pattern of core usage identified for job 350.

As depicted, job 350, predicted runtime 351, and predicted core usage 352 are sent to scheduler 304. Scheduler 304 places job 350 into job queues 320 and predicted core usage 352 are saved in job information 326. Job queues in job queues 320 can have different priorities. Scheduler 304 selects a highest priority job from a highest priority queue in job queues 320.

When job 350 is identified for processing from job queues 320, generates decision 354 for running job 350. This decision can be made using job information 326, policies 327, and host information 328.

In this example, job information 326 can include predicted core usage and predicted runtime as determined by predictor 300. The predicted core usage can take the form of a predicted core model that identifies core usage during the execution of a job. The predicted runtime identifies the period of time that a job runs.

Job information 326 can be identified for job 350 and for jobs currently running on different host machines identified in sorted host lists 329. Sorted host lists 329 is a data structure that organizes the host machines. The sorting of host machines in sorted host lists 329 can be based on free cores in ascending order. Further, sorted host lists 329 can include sort host machines sorted by the number of running jobs in increasing order. Thus, sorted host lists 329 can have host machines sorted based on free cores and running jobs. This information can be used to select host machines for consideration in running job 350.

Scheduler 304 can determine whether a host machine in identified sorted host lists 329 has attributes suitable for running job 350. Job 350 may require specific types of host attributes to run. In this example, host information 328 contains information about hosts host machines identified in sorted host lists 329. For example, host information 328 can include host attributes such as, for example, name, type, running jobs, and other information. Further, host information 328 can also include information about resources in the host machines. These resources can be, for example, memory, total cores, free cores, and other suitable information that can be used for scheduling job 350.

Policies 327 is a set of one or more rules that are used in scheduling jobs. Policies 327 can be used to implement scheduling strategies and resource limitations. For example, scheduling strategies refers to approaches or methods used to manage and allocate resources or jobs in a system. Scheduling strategies can be, for example, first-come, first-served (FCFS). This type of scheduling strategy executes jobs in the order that the jobs are received. Another scheduling strategy is preemption in which a high priority job could preempt low priority job resources.

Thus, job information 326, host information 328, and policies 327 can be used to make decision 354 on how to dispatch job 350. This decision is sent as dispatch decision 353 to cluster manager 302. Dispatch decision 353 indicates which host machine will run job 350 and can include other information needed to run job 350. In this example, job 350 can be run on a host machine in local host machines 356 in private network 359 or public cloud host machines 357 in public cloud 358.

Cluster manager 302 performs different operations to manage the execution of job 350. These operations create and manage connections with different host computers such as in local host machines 356 in local host machines 356 and public cloud host machines 357 in pub in local area network, public cloud 358.

Cluster manager 302 also manages information about host machines, job core consumption, job runtime, and other information received from proxies 306. Additionally, in addition to organizing the host machines based on attributes, cluster manager 302 sorts of host machines in sorted host lists 329. Cluster manager 302 can update job information 326 and host information 328 in scheduler 304 using this information. In other words, as information is received from proxies 306, cluster manager 302 can generate host and resource snapshots 371 that are used to update sorted host lists 329. For example, host and resource snapshots 371 can identify changes in free cores, running jobs, as well as other information.

When job 350 is sent to host machines by cluster manager 302, job 350 is sent to a proxy on a virtual machine on a host machine that has been selected to run job 350. For example, the proxy can run job 350 on a local virtual machine in local virtual machines 355 on a local host machine in local host machines 356. Local virtual machines 355 and the host machines can be located in the facilities of a particular organization or entity.

In another example, job 350 can be run on a cloud virtual machine in cloud virtual machines 361 on a public cloud host machine in public cloud host machines 357. This example, cloud virtual machines 361 can be dynamically created by public cloud host machines 357 to provide computing resources as needed or requested.

In one example, the virtual machine can be located on a local host machine or a public cloud host machine that has sufficient free cores to run job 350. When checking whether any host machine is present that can be backfilled, a check can be performed on at virtual machines on local host machine and existing virtual machine on public cloud hose machines provisioned by public cloud yet. For example, the virtual machine can be located on a host machine that has free cores and idle cores that are available for backfilling using job 350.

If resources are not available locally, job 350 is sent to public cloud 358. In this example, a public cloud virtual machine in public cloud virtual machines 361 can be allocated to run job 350. Proxies 306 manage jobs running on host machines. In this illustrative example, proxies 306 communicate with cluster manager 302 to manage the operation of host machines in processing jobs.

Proxies 306 can be located on each of the host machines in public cloud host machines 357 in public cloud 358 and local host machines 356 in private network 359. Private network 359 can be a private cloud, a local area network, a private cluster, or some other type of network.

Further, proxies 306 can collect and calculate information about running jobs and current CPU usage. This information can be collected or calculated on a periodic basis. Proxies 306 can translate the CPU usage by job into the cores used by job. For example, the cores used by job can be calculated as follows:

cores used=total_cores_on_VM*cpu_usage,

wherein total_cores_on_VM is the total number of cores allocated to the virtual machine, and cpu_usage is the percentage of time that CPU takes to process all processes that belong to an individual job. In this example, cpu_usage can be measured over a specific interval time.

For example, job1 ran on virtual machine VM1. Virtual machine VM1 had 4 cores. Once collected cpu_usage was 50%, means job1 used is 4*50%=2 cores. Proxies 306 can report core consumption for the job to cluster manager 302 in workload manager 214. This information can be stored in file or database. In this example, job CPU usage for a job can be calculated as follows:

Job CPU usage=cpu_time of all job's processes/interval *N_cores wherein cpu_time of all job's processes is CPU time used to process all processes for the job, interval is a time interval, and N_cores is a number of cores allocated to the virtual machine.

Additionally, proxies 306 can generate return information about resources available and resources in addition to core usage used by different host machines.

In this example, cluster manager 302 can use information obtained from proxies 306 to generate host and resource snapshots 371. Host and resource snapshots 371 identify the different host machines, resources available, resources used, and other information about the host machines and resource usage. A snapshot can be generated for each host machine by cluster manager 302. This information can be used by scheduler 304 to update host information 328 and sorted host lists 329.

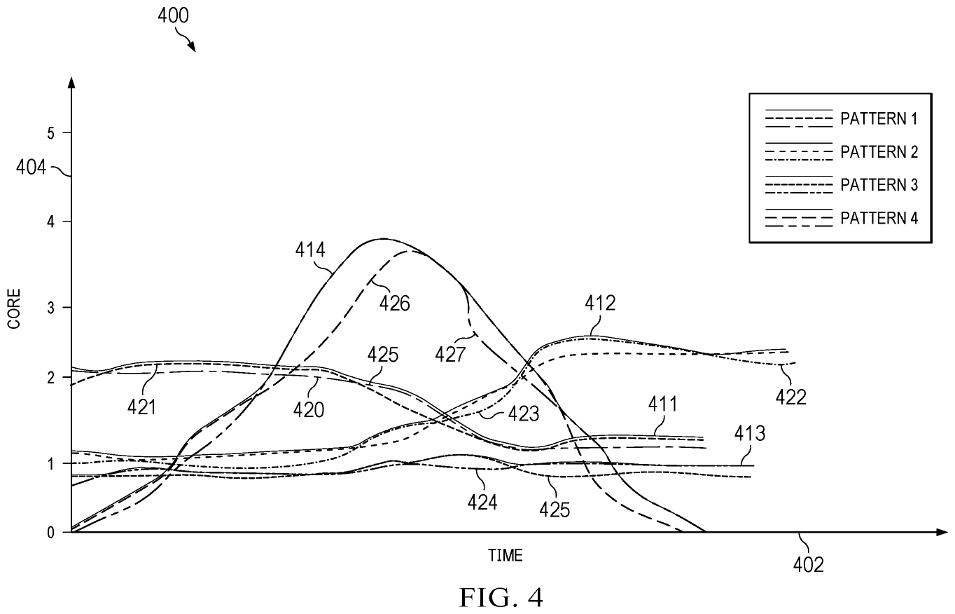

Turning next to FIG. 4, a graph depicting patterns of core usage over the lifetime of jobs is depicted in accordance with an illustrative embodiment. As depicted in graph 400, x-axis 402 is the time during the execution of jobs, and y-axis 404 identifies a number of cores used.

The different curves in graph 400 illustrate patterns of core usage by jobs during the lifetimes of the jobs. In this example, these curves can be grouped into clusters of different patterns of core usage. This classification can be performed using a classification algorithm. The classification can divide the patterns of core usage for jobs into different classifications.

In this example, the maximum value for the different curves in a classification is used to create a pattern of core usage for that particular classification. In this example, the dashed lines identify core usage for different jobs. For example, line 420, line 421, line 422, line 423, line 424, line 425, line 426, and line 427 are dashed lines that represent the core usage for particular jobs. These dashed lines can be classified into clusters. This classification can be performed using a machine learning model.

As depicted, four classifications of patterns of core usage are present. In these clusters, pattern 1 includes line 420 and line 421; pattern 2 includes line 422 and line 423; pattern 3 includes line 424 and line 425; and pattern 4 includes line 426, and line 427. These lines illustrate the usage of cores by jobs that are classified to particular pattern.

The lines for the core usage in each cluster are processed to generate a line for the pattern of core usage in that cluster. For example, the maximum value from the lines in a cluster are selected to create the line for the pattern of core usage for that cluster. As depicted, the patterns of core usage are identified by solid lines and are pattern 1 411, pattern 2 412, pattern 3 413, and pattern 4 414 for core usage in these clusters. These patterns of core usage can be used to predict core usage for currently executing jobs as well as a new job to be dispatched for processing. For example, when a new job is submitted with host attributes, the predicted runtime and predicted core usage for the new job can be determined for job runtime=t. The new job can be classified to fit into one of the patterns of core usage. This classification can also be performed using a machine learning model. In this example pattern of core usage for the new job in graph 400 is f (x), which is the line that is a function of time which is x.

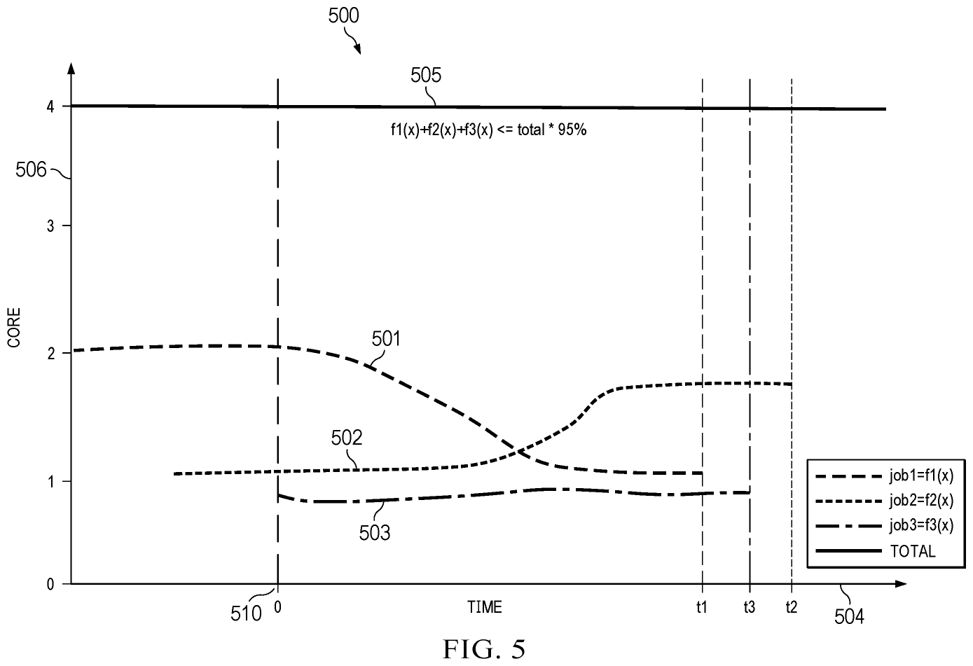

Turning next to FIG. 5, a graph depicting core usage for jobs on a virtual machine is depicted in accordance with an illustrative embodiment. As depicted in graph 500, x-axis 504 is the time during the execution of jobs, and y-axis 506 identifies a number of cores used.

In graph 500, core usage is depicted for currently running jobs job1 and job2 on a virtual machine. Additionally, a new job, job3, is contemplated for running on the virtual machine starting at time 510. As illustrated, job1 and job2 have already been running prior to time 510.

In this example, job1 has a lifetime of t1 and job2 has a lifetime of t2. Job3 is a job that that is being considered to backfill has a predicted runtime of t3.

As depicted, core usage for job1 is identified by line 501 and core usage for job2 is identified by line 502. In this example, predicted core usage for job3 is identified by line 503.

In this example, if during the predicted runtime of job3, combined core usage by job1 and job2 is always less than a threshold of 95% of the total cores for the host machine. In this example, the total number cores are for as indicated by line 505. As result, job3 can be run using remaining idle cores from job1 and job2 as part of a backfilling process.

Thus, within the timeframe of t3 4 running job3, an area under line 503 with respect to x-axis 504 can be determined during the time t3 that job3 is predicted to run. Areas under line 502 for job2 and line 501 for job1 can be determined with respect to x-axis 504. These areas are summed to form a total area and if the total area is less than 95% of the area under line 505 for the total number cores, job3 can backfill job1 and job2.

The threshold level of 95% is selected to take into account system processes and potential errors in calculations. In other illustrative examples, other threshold levels can be used.

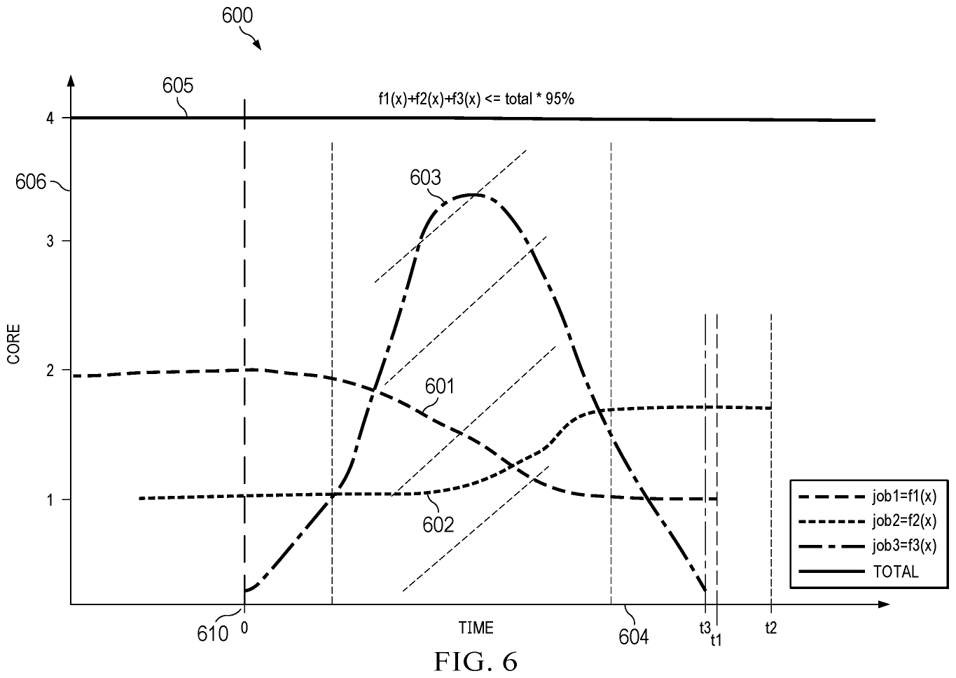

Turning next to FIG. 6, a graph depicting core usage for jobs on a virtual machine is depicted in accordance with an illustrative embodiment. As depicted in graph 600, x-axis 604 is the time during the execution of jobs, and y-axis 606 identifies a number of cores used.

In graph 600, core usage is depicted for currently running jobs job1 and job2 on a virtual machine. Additionally, a new job, job3, is contemplated for running on the virtual machine starting at time 610 and has a predicted runtime of t3. As illustrated, job1 and job2 have already been running prior to time 610.

In this example, job1 has a lifetime of t1 and job2 has a lifetime of t2. Job 3 is a job that is being considered to backfill job1 and job2.

As depicted, core usage for job1 is identified by line 601 and core usage for job2 is identified by line 602. In this example, predicted core usage for job3 is identified by line 603. The total number of cores allocated to this virtual machine is 4 core as indicated by line 605.

In this example, areas can be determined under these 3 lines and added to form in total area. In this example, During the predicted runtime of job3, the combined core usage of job1 and job2 along with the core usage of job3 is not always less than 95% of total cores on the host machine identified by line 605.

As a result, job3 cannot utilize the remaining idle cores from job1 and job2 through a backfilling process in this example. In this case, the scheduler makes a scheduling decision to request a new virtual machine from the public cloud.

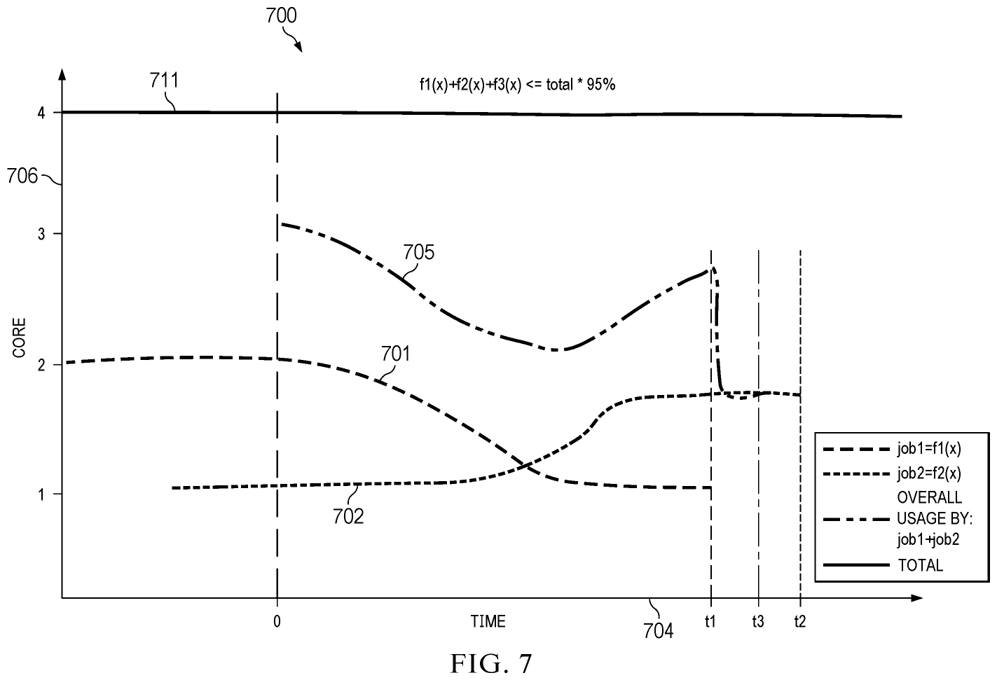

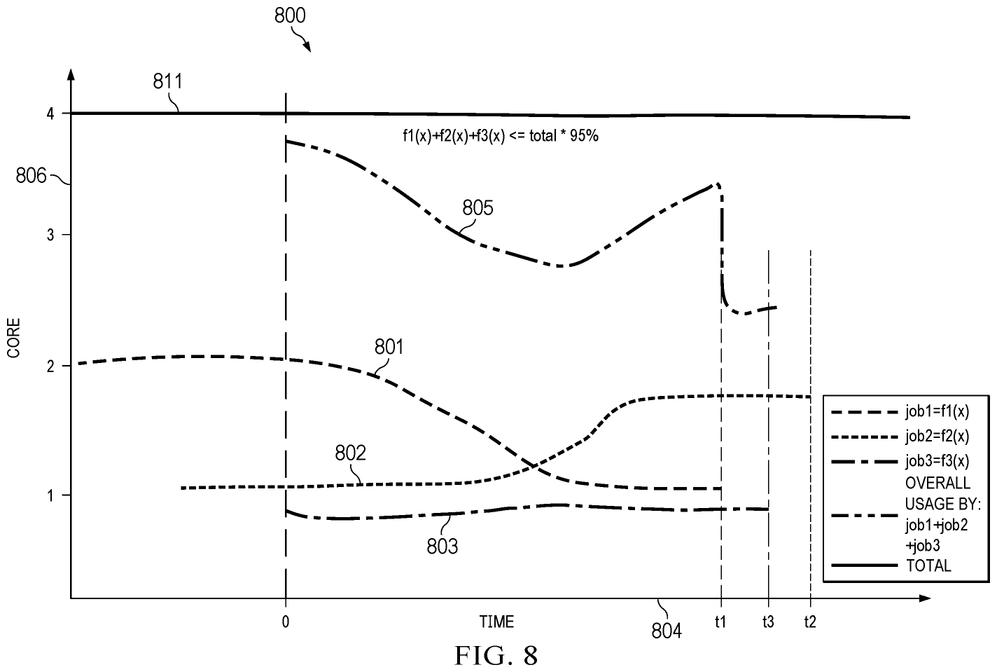

With reference now to FIG. 7 and FIG. 8, graphs showing resource usage are depicted in accordance with an illustrative embodiment. Turning first to FIG. 7, a graph illustrating processor resource usage without backfilling is depicted in accordance with an illustrative embodiment. As depicted in graph 700, x-axis 704 is the time during the execution of jobs, and y-axis 706 identifies a number of cores used.

In graph 700, core usage is depicted for currently running jobs job1 and job2 on a virtual machine. Line 701 is the core usage by job1 and line 702 is the core usage by job 2. In this example, a new job, job3, is not run on the virtual machine with job1 and job 2. Line 705 represents overall core usage on the virtual machine by job1 and job2 over time. Line 711 illustrates the number cores available to run jobs in the virtual machine, which is four cores in this example. In this example, backfilling is not performed and an additional job, job3 is not run on this virtual machine.

With reference next to FIG. 8, a graph illustrating processor resource usage with backfilling is depicted in accordance with an illustrative embodiment. As depicted in graph 800, x-axis 804 is the time during the execution of jobs, and y-axis 806 identifies a number of cores used.

In graph 800, core usage is depicted for currently running jobs job1 and job2 on a virtual machine. Line 801 is the core usage by job1 and line 802 is the core usage by job2. Line 801 is the same as line 701 in FIG. 7 for job1, and line 802 is the same as line 702 in FIG. 7 for job2. Line 811 illustrates the number cores available to run jobs in the virtual machine, which is four cores in this example.

In this example, backfilling occurs and a new job, job3, on the virtual machine starting with job1 and job2. The core usage by job3 is represented by line 803.

Line 805 represents overall core usage on the virtual machine by job1, job2, and job3 over time. As can be seen, a greater level for usage of cores is present as compared to line 705 in FIG. 7. Greater efficiency in using processor resources is present through backfilling job1 and job2 with job3 on the same virtual machine. In this case, with backfilling, a virtual machine on a different host machine is not needed to run job3. This type of backfilling can also reduce costs when additional host machine is not available locally and job3 would require requesting a virtual machine from a public cloud.

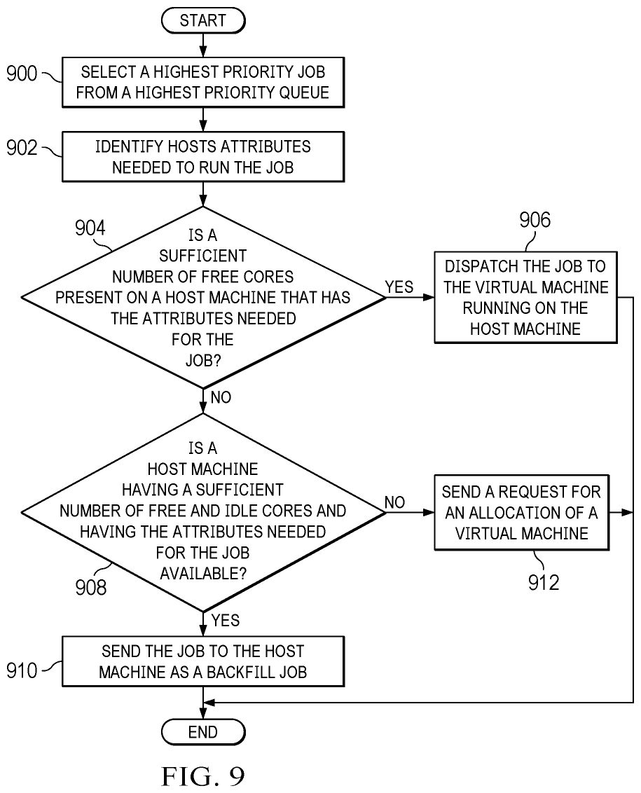

Turning now to FIG. 9, a flowchart of a process for managing job execution is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in workload manager 214 in computer system 212 in FIG. 2 and in particular using a scheduler in workload manager 214 as depicted in FIG. 3.

The process begins by selecting a highest priority job from a highest priority queue (step 900). The process identifies hosts attributes needed to run the job (step 902). The process determines whether a sufficient number of free cores are present on a host that has the attributes needed for the job (step 904). In step 904, this determination can be made using a list of host machines sorted by free cores.

If sufficient number of free cores are present on a host machine that has the attributes needed for the job, the process dispatches the job to the virtual machine running on the host machine (step 906). The process terminates thereafter.

With reference again to step 904, if a host with a sufficient number of free cores having attributes needed for the job are not found, the process determines whether a host machine having a sufficient number of free and idle cores and having the attributes needed for the job is available (step 908). In step 908, this determination can be made by considering the predicted runtime and predicted core usage for the job. The predicted runtime and predicted core usage can be compared to host machines running jobs to determine whether sufficient resources will be present over the period of time that the job runs taking account the jobs currently running on the host machines.

If a host machine having a sufficient number free and idle cores and having the attributes needed for the job is available, the process sends the job to the host machine as a backfill job (step 910). The process terminates thereafter. In step 910, the backfill job is running to backfill jobs currently running on the host machine.

With reference again to step 908, if a host machine having a sufficient number of free and idle cores and having the attributes needed for the job is not available, the process sends a request for an allocation of a virtual machine (step 912). The process terminates thereafter. In step 912, the request can be sent for a virtual machine using a host machine the same network as a host machines be considered. In another example, the request be sent to another network such as a public cloud or a data center.

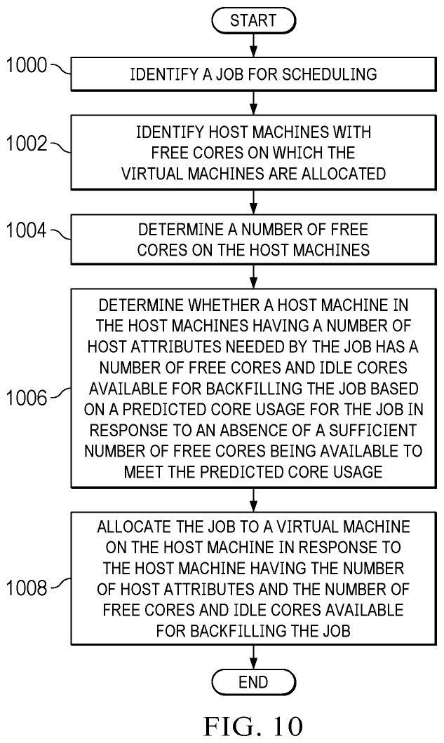

Turning next to FIG. 10, a flowchart of a process for job execution on virtual machines is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in workload manager 214 in computer system 212 in FIG. 2.

The process begins by identifying a job for scheduling (step 1000). In this example, the job can be identified from a job queue or can be received in a request.

The process identifies host machines with free cores on which the virtual machines are allocated (step 1002). The process determines a number of free cores on the host machines (step 1004). The process determines whether a host machine in the host machines having a number of host attributes needed by the job has a number of free cores and idle cores available for backfilling the job based on a predicted core usage for the job in response to an absence of a sufficient number of free cores being available to meet the predicted core usage (step 1006).

The process allocates the job to a virtual machine on the host machine in response to the host machine having the number of host attributes and the number of free cores and idle cores available for backfilling the job (step 1008). The process terminates thereafter.

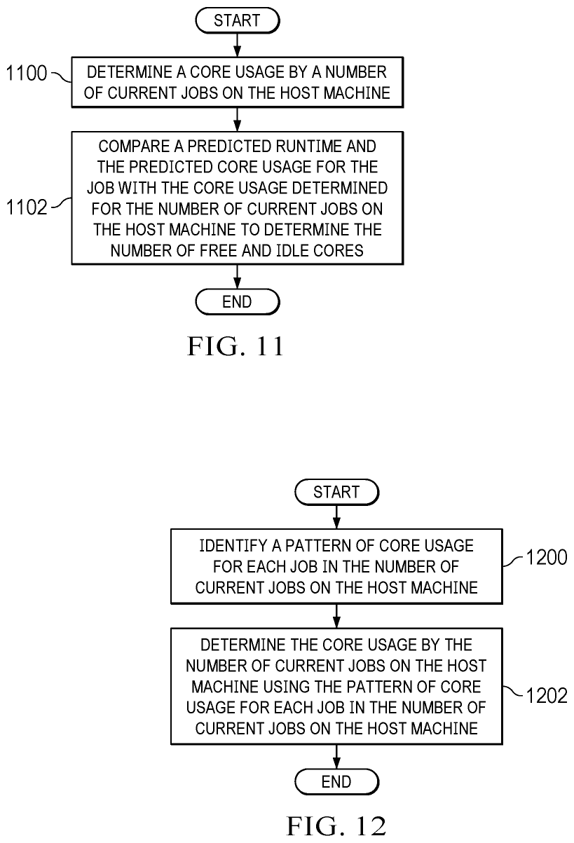

With reference now to FIG. 11, a flowchart of process for determining whether the host machine in the host machines having the number of host attributes needed by the job has the number of free cores and idle cores is depicted in accordance with an illustrative embodiment. The process in this figure is an example of an implementation for step 1006 in FIG. 10.

The process determines a core usage by a number of current jobs on the host machine (step 1100). The process compares a predicted runtime and the predicted core usage for the job with the core usage determined for the number of current jobs on the host machine to determine the number of free and idle cores (step 1102). The process terminates thereafter.

Next in FIG. 12, a flowchart of a process for determining core usage by the number of current jobs is depicted in points with an illustrative embodiment. The process in this figure is an example of an implementation for step 1100 in FIG. 11.

The process identifies a pattern of core usage for each job in the number of current jobs on the host machine (step 1200). The process determines the core usage by the number of current jobs on the host machine using the pattern of core usage for each job in the number of current jobs on the host machine (step 1202). The process terminates thereafter.

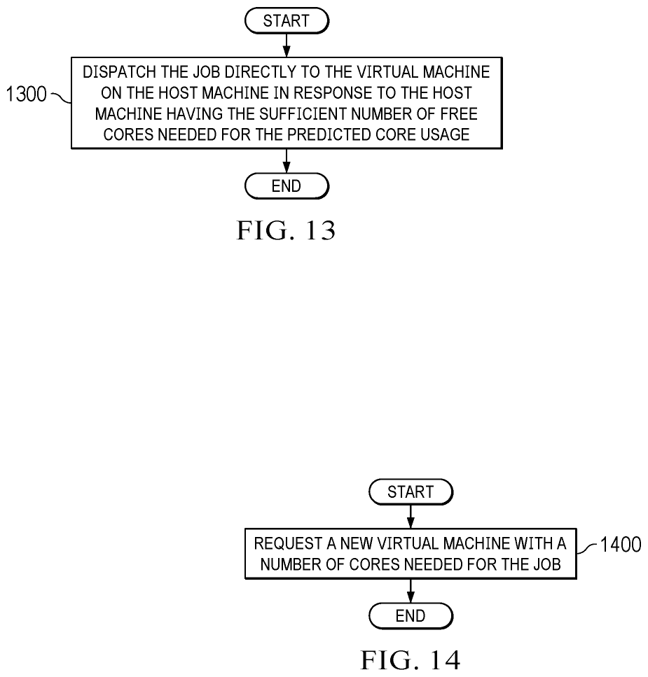

Turning to FIG. 13, a flowchart of process for dispatching a job is depicted in accordance with an illustrative embodiment. The process in this figure is an example of an additional step that can be performed with the steps in FIG. 10.

The process dispatches the job directly to the virtual machine on the host machine in response to the host machine having the sufficient number of free cores needed for the predicted core usage (step 1300). The process terminates thereafter.

In FIG. 14, an illustration of a flowchart of a process for requesting a new virtual machine is depicted in accordance with an illustrative embodiment. The process in this figure is an example of an additional step that can be performed with the steps in FIG. 10.

The process requests a new virtual machine with a number of cores needed for the job (step 1400). The process terminates thereafter. In step 1400, the process can send the request for the virtual machine. This request can be sent to management software or a hypervisor in a local area network, a private cloud, a public cloud, or some other network.

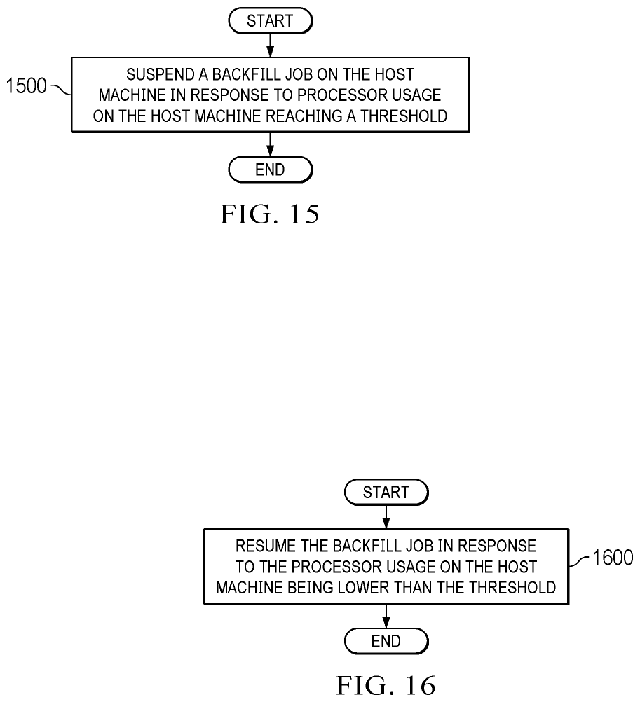

With reference now to FIG. 15, a flowchart of a process for managing a job is depicted in accordance with an illustrative embodiment. The process in this figure is an example of an additional step that can be performed with the steps in FIG. 10.

The process suspends a backfill job on the host machine in response to processor usage on the host machine reaching a threshold (operation 1500). The process terminates thereafter. In this example, the threshold for processor usage can be based on a number of different factors. For example, some processor resources may be reserved for the host system, and operating system, or other processes.

Next in FIG. 16, an illustration of a flowchart of a process for managing a job is depicted in accordance with an illustrative embodiment. The process in this figure is an example of an additional step that can be performed with the steps in FIG. 15.

The process resumes the backfill job in response to the processor usage on the host machine being lower than the threshold (operation 1600). The process terminates thereafter. In example in FIG. 15 and FIG. 16, a native job on the host machine has a higher priority than a backfill job on the host machine.

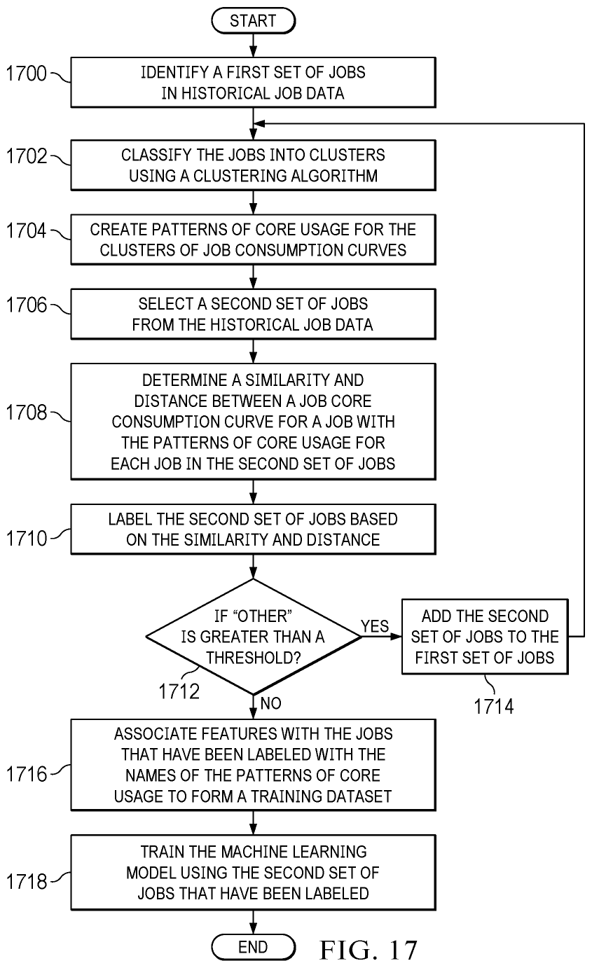

With reference next to FIG. 17, a flowchart of a process for training a machine learning model to determine a pattern of core usage is depicted in accordance with an illustrative embodiment. The process in FIG. 17 can be implemented in hardware, software, or both. When implemented in software, the process can take the form of program instructions that are run by one of more processor units located in one or more hardware devices in one or more computer systems. For example, the process can be implemented in workload manager 214 in computer system 212 in FIG. 2 and in particular using a scheduler in workload manager 214 as depicted in FIG. 3.

The process begins by identifying a first set of jobs in historical job data (step 1700). In step 1700, N jobs are in the first set of jobs. This job data includes information about different jobs. The information can include, for example, user submitting the job, application, project, command, command argument, input_data_size, resource requirement, used memory, runtime, job core consumption curve, and other suitable information. The job core consumption curve can be data representing the core usage during the running of the job.

The process classifies the jobs into clusters using a clustering algorithm (step 1702). In this example, information for N jobs is selected for the training dataset for the clustering algorithms. The clustering algorithms classify the job core consumption curves into different clusters. The different clusters represent different job patterns. Each cluster can be labeled with a pattern name. The pattern name is a label value for jobs to represent job pattern.

The process creates patterns of core usage for the clusters of job consumption curves (step 1704). In step 1704, the job core consumption curves in a cluster are processed to create a pattern of core usage. In this step, the maximum value for core usage for each point in time for the job core consumption curves are used to form a new curve that is the pattern of core usage for the cluster. For example, a training dataset has N jobs. After processing the jobs using clustering algorithms, three clusters are identified. Names for the patterns of core usage represented by the curves are A, B, C, where A curve=f_a (x); B curve=f_b (x); C curve=f_c (x); and Other=none. In this example, Other is a placeholder for a pattern of core usage.

The process selects a second set of jobs from the historical job data (step 1706). In this example, N1 jobs are in the second set of jobs. The process determines a similarity and distance between a job core consumption curve for a job with the patterns of core usage for each job in the second set of jobs (step 1708). The process labels the second set of jobs based on the similarity and distance (step 1710). In step 1710, the job is labeled with name for one of the patterns of core usage if the similarity and distance between job core consumption curve for the job in the second set of jobs and one of the patterns of core usage are sufficiently close. A threshold value can be used to determine when the job consumption curve is sufficiently close in similarity and distance. Further in step 1710, if the job consumption curve is not sufficiently close in similarity and distance, then the job core consumption curve labeled as “Other”.

A determination is made as to whether “Other” is greater than a threshold (step 1712). This threshold can be set to a value that indicates that too many jobs are present that cannot be labeled using the patterns of core usage. If “Other” is greater than the threshold, the process adds the second set of jobs to the first set of jobs (step 1714). The process then returns to step 1702.

Otherwise, the process associates features with the jobs that have been labeled with the names of the patterns of core usage to form a training dataset (step 1716). In step 1716, features can be one or more of the job attributes. For example, the features for them training dataset can be submit user, application, project, command, command argument, data_size, resource requirement. The labels for the training dataset can be the names for the patterns of core usage.

The process trains the machine learning model using the second set of jobs that have been labeled (step 1718). The process terminates thereafter.

The result of this process is a machine learning model that can be used to determine predicted core usage for jobs. For example, features for a new job can be input into the machine learning model. The machine learning model outputs a pattern of core usage for the job. For example, the output identifying pattern of core usage can be A, B, C, or Other. With the pattern of core usage, the core usage is determined for different points in time during the running of the job. In this example, the identification of “Other” as a pattern of core usage means that a pattern cannot be identified. In this situation, the job is not considered for backfilling.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

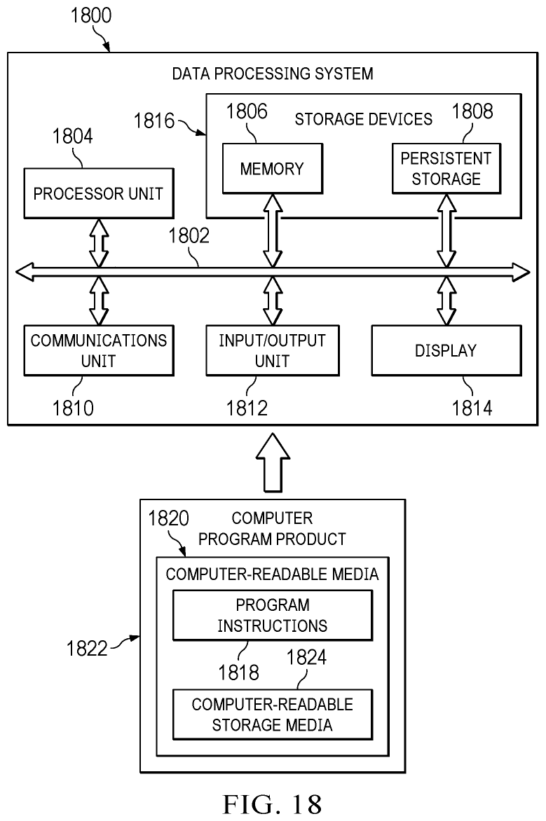

Turning now to FIG. 18, a block diagram of a data processing system is depicted in accordance with an illustrative embodiment. Data processing system 1800 can be used to implement computers and computing devices in computing environment 100 in FIG. 1. Data processing system 1800 can also be used to implement computer system 212 in FIG. 2. In this illustrative example, data processing system 1800 includes communications framework 1802, which provides communications between processor unit 1804, memory 1806, persistent storage 1808, communications unit 1810, input/output (I/O) unit 1812, and display 1814. In this example, communications framework 1802 takes the form of a bus system.

Processor unit 1804 serves to execute instructions for software that can be loaded into memory 1806. Processor unit 1804 includes one or more processors. For example, processor unit 1804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1804 can be implemented using one or more heterogeneous processor systems in which a main processor is present with secondary processors on a single chip. As another illustrative example, processor unit 1804 can be a symmetric multi-processor system containing multiple processors of the same type on a single chip.

Memory 1806 and persistent storage 1808 are examples of storage devices 1816. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1816 may also be referred to as computer readable storage devices in these illustrative examples. Memory 1806, in these examples, can be, for example, a random-access memory or any other suitable volatile or non-volatile storage device. Persistent storage 1808 may take various forms, depending on the particular implementation.

For example, persistent storage 1808 may contain one or more components or devices. For example, persistent storage 1808 can be a hard drive, a solid-state drive (SSD), a flash memory, a rewritable optical disk, a rewritable magnetic tape, or some combination of the above. The media used by persistent storage 1808 also can be removable. For example, a removable hard drive can be used for persistent storage 1808.

Communications unit 1810, in these illustrative examples, provides for communications with other data processing systems or devices. In these illustrative examples, communications unit 1810 is a network interface card.

Input/output unit 1812 allows for input and output of data with other devices that can be connected to data processing system 1800. For example, input/output unit 1812 may provide a connection for user input through at least one of a keyboard, a mouse, or some other suitable input device. Further, input/output unit 1812 may send output to a printer. Display 1814 provides a mechanism to display information to a user.

Instructions for at least one of the operating system, applications, or programs can be located in storage devices 1816, which are in communication with processor unit 1804 through communications framework 1802. The processes of the different embodiments can be performed by processor unit 1804 using computer-implemented instructions, which may be located in a memory, such as memory 1806.

These instructions are referred to as program instructions, computer usable program instructions, or computer readable program instructions that can be read and executed by a processor in processor unit 1804. The program instructions in the different embodiments can be embodied on different physical or computer readable storage media, such as memory 1806 or persistent storage 1808.

Program instructions 1818 are located in a functional form on computer readable media 1820 that is selectively removable and can be loaded onto or transferred to data processing system 1800 for execution by processor unit 1804. Program instructions 1818 and computer readable media 1820 form computer program product 1822 in these illustrative examples. In the illustrative example, computer readable media 1820 is computer readable storage media 1824.

Computer readable storage media 1824 is a physical or tangible storage device used to store program instructions 1818 rather than a medium that propagates or transmits program instructions 1818. Computer readable storage media 1824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1818 can be transferred to data processing system 1800 using a computer readable signal media. The computer readable signal media are signals and can be, for example, a propagated data signal containing program instructions 1818. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1820” can be singular or plural. For example, program instructions 1818 can be located in computer readable media 1820 in the form of a single storage device or system. In another example, program instructions 1818 can be located in computer readable media 1820 that is distributed in multiple data processing systems. In other words, some instructions in program instructions 1818 can be located in one data processing system while other instructions in program instructions 1818 can be located in one data processing system. For example, a portion of program instructions 1818 can be located in computer readable media 1820 in a server computer while another portion of program instructions 1818 can be located in computer readable media 1820 located in a set of client computers.

The different components illustrated for data processing system 1800 are not meant to provide architectural limitations to the manner in which different embodiments can be implemented. In some illustrative examples, one or more of the components may be incorporated in or otherwise form a portion of, another component. For example, memory 1806, or portions thereof, may be incorporated in processor unit 1804 in some illustrative examples. The different illustrative embodiments can be implemented in a data processing system including components in addition to or in place of those illustrated for data processing system 1800. Other components shown in FIG. 18 can be varied from the illustrative examples shown. The different embodiments can be implemented using any hardware device or system capable of running program instructions 1818.

Thus, illustrative embodiments of the present invention provide a computer implemented method, computer system, and computer program product for the execution of jobs on virtual machines. A number of processor units identifies a job for scheduling. The number of processor units identifies host machines with free cores on which the virtual machines are allocated. The number of processor units determines a number of free cores on the host machines. The number of processor units determines whether a host machine in the host machines having a number of host attributes needed by the job has a number of free cores and idle cores available for backfilling the job based on a predicted core usage for the job in response to an absence of a sufficient number of free cores being available to meet the predicted core usage. The number of processor units dispatches the job to a virtual machine on the host machine in response to the host machine having the number of host attributes and the number of free cores and idle cores available for backfilling the job.

As result, increased efficiency is present in running jobs on different host machines. In one or more illustrative examples, a new job can be run with other jobs as a backfill job to increase processor usage on that host machine. By backfilling, the need to allocate another virtual machine and additional resources or that virtual machine can be reduced or avoided.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing job execution on virtual machines, the method comprising:
identifying, by a number of processor units, a job for scheduling;
identifying, by the number of processor units, host machines with free cores on which the virtual machines are allocated;
determining, by the number of processor units, a number of free cores on the host machines;
determining, by the number of processor units, whether a host machine in the host machines having a number of host attributes needed by the job has a number of free cores and idle cores available for backfilling the job based on a predicted core usage for the job in response to an absence of a sufficient number of free cores being available to meet the predicted core usage; and
dispatching, by the number of processor units, the job to a virtual machine on the host machine in response to the host machine having the number of host attributes and the number of free cores and idle cores available for backfilling the job.

2. The computer implemented method of claim 1, wherein determining, by the number of processor units, whether a host machine in the host machines having the number of host attributes needed by the job has the number of free cores and idle cores comprises:
determining, by the number of processor units, a core usage by a number of current jobs on the host machine; and
comparing, by the number of processor units, a predicted runtime and the predicted core usage for the job with the core usage determined for the number of current jobs on the host machine to determine the number of free and idle cores.

3. The computer implemented method of claim 2, wherein determining, by the number of processor units, the core usage by the number of current jobs comprises:
identifying, by the number of processor units, a pattern of core usage for each job in the number of current jobs on the host machine; and
determining, by the number of processor units, the core usage by the number of current jobs on the host machine using the pattern of core usage for each job in the number of current jobs on the host machine.

4. The computer implemented method of claim 1 further comprising:
dispatching, by the number or processor units, the job directly to the virtual machine on the host machine in response to the host machine having the sufficient number of free cores needed for the predicted core usage.

5. The computer implemented method of claim 1 further comprising:
requesting, by the number of processor units, a new virtual machine with a number of cores needed for the job.

6. The computer implemented method of claim 1, wherein the job is a highest priority job in a queue in a highest priority queue.

7. The computer implemented method of claim 1 further comprising:
suspending, by the number of processor units, a backfill job on the host machine in response to processor usage on the host machine reaching a threshold.

8. The computer implemented method of claim 7 further comprising:
resuming, by the number of processor units, the backfill job in response to the processor usage on the host machine being lower than the threshold.

9. The computer implemented method of claim 7, wherein a native job on the host machine has a higher priority than a backfill job on the host machine.

10. A computer system comprising:
a number of processor units, wherein the number of processor units executes program instructions to:
identify a job for scheduling;
identify host machines with free cores on which virtual machines are allocated;
determine a number of free cores on the host machines;
determine whether a host machine in the host machines having a number of host attributes needed by the job has a number of free cores and idle cores available for backfilling the job based on a predicted core usage for the job in response to an absence of a sufficient number of free cores being available to meet the predicted core usage; and
dispatch the job to a virtual machine on the host machine in response to the host machine having the number of host attributes and the number of free cores and idle cores available for backfilling the job.

11. The computer system of claim 10, wherein in determining whether the host machine in the host machines having the number of host attributes needed by the job has the number of free cores and idle cores, the number of processor units further executes the program instructions to:
determine a core usage by a number of current jobs on the host machine; and
compare a predicted runtime and the predicted core usage for the job with the core usage determined for the number of current jobs on the host machine to determine the number of free and idle cores.

12. The computer system of claim 11, wherein in determining the core usage by the number of current jobs, the number of processor units further executes the program instructions to:
identify a pattern of core usage for each job in the number of current jobs on the host machine; and
determine the core usage by the number of current jobs on the host machine using the pattern of core usage for each job in the number of current jobs on the host machine.

13. The computer system of claim 10, wherein the number of processor units further executes the program instructions to:
dispatch the job directly to the virtual machine on the host machine in response to the host machine having the sufficient number of free cores needed for the predicted core usage.

14. The computer system of claim 10, wherein the number of processor units further executes the program instructions to:
request a new virtual machine with a number of cores needed for the job.

15. The computer system of claim 10, wherein the job is a highest priority job in a queue in a highest priority queue.

16. The computer system of claim 10, wherein the number of processor units further executes the program instructions to:
suspend a backfill job on a host machine in response to processor usage on the host machine reaching a threshold.

17. The computer system of claim 16, wherein the number of processor units further executes the program instructions to:
resume the backfill job in response to the processor usage on the host machine being lower than the threshold.

18. The computer system of claim 16, wherein a native job on a host machine has a higher priority than a backfill job on the host machine.

19. A computer program product for managing execution of jobs on virtual machines, the computer program product comprising a computer readable storage medium having program instructions embodied therewith, the program instructions executable by a computer system to cause the computer system to:
identify a job for scheduling;
identify host machines with free cores on which the virtual machines are allocated;
determine a number of free cores on the host machines;
determine whether a host machine in the host machines having a number of host attributes needed by the job has a number of free cores and idle cores available for backfilling the job based on a predicted core usage for the job in response to an absence of a sufficient number of free cores being available to meet the predicted core usage; and
dispatch the job to a virtual machine on the host machine in response to the host machine having the number of host attributes and the number of free cores and idle cores available for backfilling the job.

20. The computer program product of claim 19, wherein in determining whether the host machine in the host machines having the number of host attributes needed by the job has the number of free cores and idle cores, the program instructions are further executable by the computer system to cause the computer system to:
determine a core usage by a number of current jobs on the host machine; and
compare a predicted runtime and the predicted core usage for the job with the core usage determined for the number of current jobs on the host machine to determine the number of free and idle cores.
